(19) United States
(12) Patent Application Publication
(10) Pub. No.: US 2017/0019019 A1
(43) Pub. Date: Jan. 19, 2017

(54) POWER SUPPLY OPERATING IN RIPPLE MODE AND CONTROL METHOD THEREOF

(71) Applicant: MStar Semiconductor, Inc., Hsinchu Hsien (TW)

(72) Inventors: Kai-Ting Ho, Zhubei City (TW); Tsang-Chuan Lin, Zhubei City (TW)

(21) Appl. No.: 15/193,644

(22) Filed: Jun. 27, 2016

(30) Foreign Application Priority Data
Jul. 16, 2015 (TW) 104123040

(51) Int. Cl. H02M 3/04

(52) U.S. Cl. CPC H02M 3/04

(57) ABSTRACT

A power supply for powering a load includes a power converter, a remote output node, a transmission line, a feedback circuit and a power controller. The power converter converts an input power to a near output power, and includes a power input node receiving the input power and an output node outputting the near output power. The remote output node provides a remote output power to the load. The transmission line is connected between the near output node and the remote output node. The feedback circuit generates a feedback signal according to voltage levels of the remote output node and the near output node. The power controller controls the power converter, and outputs a control signal to the power converter according to the feedback signal and a reference signal to accordingly convert the input power to the near output power.

This application claims the benefit of Taiwan application Serial No. 104123040, filed Jul. 16, 2015, the subject matter of which is incorporated herein by reference.

### BACKGROUND OF THE INVENTION

Field of the Invention

The invention relates in general to a power supply and a control method thereof, and more particularly to a feedback control method of a switching mode power supply.

Description of the Related Art

A switching mode power supply provides outstanding conversion efficiency, and is thus extensively applied for power conversion between different voltages.

FIG. 1 shows a conventional switching mode power supply 10 that powers a load 20. The switching mode power supply 10 includes a buck converter 12, which converts an input voltage power V_{IN} in a relatively high voltage to an output voltage power V_{O-N} in a relatively low voltage. Voltage information of the output voltage power V_{O-N} is fed back to a feedback node FB of a power controller 14 via a voltage dividing circuit 16. The power controller 14 accordingly generates a pulse-width modulation (PWM) signal to control the buck converter 12, such that the output voltage power V_{O-N} outputted from the buck converter 12 is substantially stabilized at a predetermined value. For example, when a feedback voltage V_{FB} on the feedback node FB is lower than a set value, the power controller 14 provides a pulse at a high side HS to cause a high side power switch SW_{HS} to be kept tuned on in a on-time T_{ON}. At this point, the input voltage power V_{IN} starts powering an inductor L and an output capacitor C_{O}. When the on-time T_{ON} ends, the power controller 14 turns on a low side power switch SW_{HS} via a low side node LS until the energy stored in the inductor L is completely released to the output capacitor C_{O}. If the feedback voltage V_{FB} exceeds the set value, the high side power switch SW_{HS} is kept turned off. In other words, when the voltage of the output voltage power V_{O-N} is too low, the input voltage power V_{IN} converts electric energy through the inductor L to the output voltage power V_{O-N} to pull up the voltage of the output voltage power V_{O-N}. Conversely, when the voltage of the output voltage power V_{O-N} is too high, such electric energy conversion does not take place. Thus, the voltage of the output voltage power V_{O-N} may substantially stabilize at a predetermined value. However, in certain applications, a power converter and a driven load are quite distant from each other. As shown in FIG. 1, the load 20, instead of directly connected to the output voltage power V_{O-N}, is spaced by the lengthy transmission line 18, e.g., a printed copper conducting line on a printed circuit board (PCB). For illustration purposes, in the application, a contact of the transmission line 18 and the power converter 12 is referred to as a near output node O_{N}, and a contact of the transmission line 18 and the load 20 is referred to as a remote output node O_{R}. The output voltage power V_{O-N} on the near output node O_{N} is similarly referred to as a near output power V_{O-N} and the remote output node O_{R} provides a remote output power V_{O-R}.

Despite that the switching mode power supply 10 in FIG. 1 is capable of substantially stabilizing the voltage of the near output power V_{O-N} at a predetermined value, it is incapable of stabilizing the voltage of the remote output power V_{O-R}. For example, when the load 20 is light or when there is no load at all, the current passing through the transmission line 18 is almost negligible, in a way that the voltages of the remote output power V_{O-R} and the near output power V_{O-N} are approximately equal. However, when the load 20 is heavy, the current passing through the transmission line 18 becomes sizable. Thus, the voltage drop generated by parasitic resistance of the transmission line 18 causes the voltage of the remote output power V_{O-R} to be significantly lower than the voltage of the near output power V_{O-N}. However, the remote output power V_{O-R} is in fact the power supply that powers the load 20. Therefore, it is important that the output power V_{O-R} have a stable voltage that should not be affected by the size of the load 20.

### SUMMARY OF THE INVENTION

The present invention discloses a power supply for powering a load, comprising: a power converter, converting an input power to a near output power, comprising: a power input node, receiving the input power; and a near output node, outputting the near output power; a remote output node, providing a remote output power to the load; a transmission line, connected between the near output node and the remote output node; a feedback circuit, generating a feedback signal according to a voltage level of the remote output power and a voltage level of the near output power; and a power controller, outputting control signal to the power converter according to the feedback signal and a reference signal, the power converter converting the input power to the near output power according to the control signal.

A control method for controlling a power supply to power a load s provided. The power supply includes a power input node and a near output node. The power input node receives an input power. The near output node outputs a near output power, which is converted from the input power. A remote output node provides a remote output power to power a load. A transmission line is connected between the near output node and the remote output node. The control method includes: receiving the remote output power; receiving the near output power; generating a feedback signal according to voltage levels of the remote output power and the near output power; generating a control signal according to the feedback signal and a reference signal; and converting the input power to the near input power according to the control signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a conventional switching mode power supply;

FIG. 2 is another switching mode power supply;

FIG. 3 is a power supply according to an embodiment of the present invention;

FIG. 4 depict a signal S_{HS} on a high side node HS, a signal S_{LS} on a low side node LS, a feedback signal V_{FB} on a feedback node FB, and a digital comparison result S_{OUT};

FIG. 5 shows a control method for an on-time T_{ON}; and

FIG. 6 shows another control method for an on-time T_{ON}.

### DETAILED DESCRIPTION OF THE INVENTION

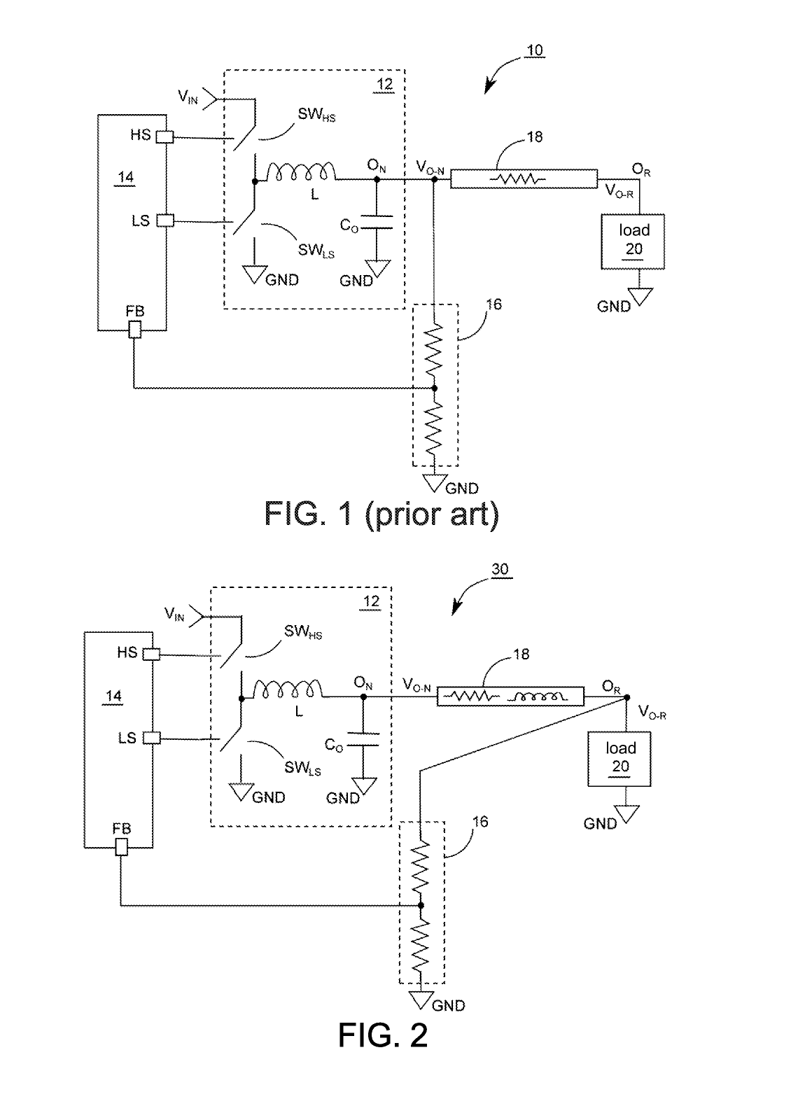

To overcome issues of the prior art, one possible solution is to change the near sensing in FIG. 1 to remote sensing, as shown in FIG. 2. FIG. 2 shows another switching mode power supply 30 that powers a load 20. A voltage dividing circuit 16 in FIG. 2 is connected between a remote output node O_{R} and a ground node GND, detects the voltage of the remote output power V_{O-R}, and feeds the detection result back to a feedback node FB of a power controller 14.

Theoretically, as the power controller 14 in FIG. 2 detects the voltage of the remote output power V_{O-R}, the switching mode power supply 30 is expectantly capable of stabilizing the voltage of the remote output power V_{O-R} at a predetermined value. However, in practice, the switching mode power supply 30 in FIG. 2 may still contain the issue of an unstable remote output power V_{O-R}, or an issue of an excessively large output ripple. In application specifications of many power controllers, it is clearly specified that the power controllers are not applicable to remote sensing. One reason for the above is the effects of parasitic inductance and resistance in the transmission line 18. Once the transmission line 18 gets lengthy, the amount of parasitic inductance and resistance therein becomes very sizable. The inductance and resistance form a low-pass circuit that not only generates signal delay but also causes instability in the overall control loop.

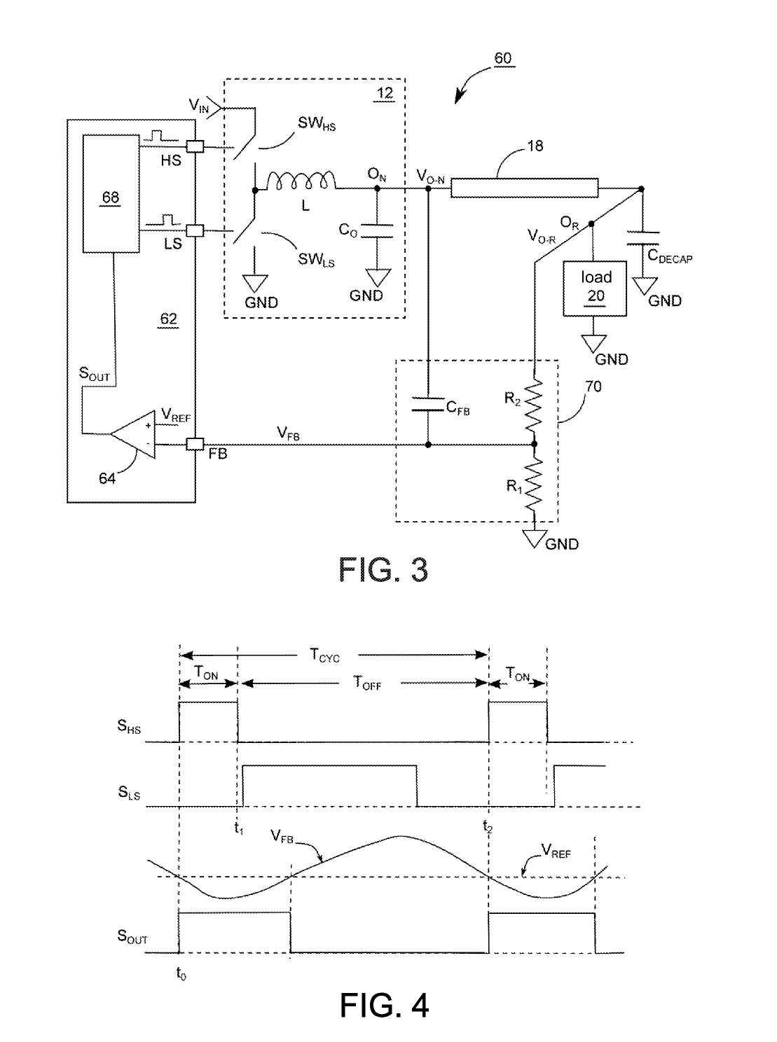

FIG. 3 shows a power supply 60 according to an embodiment of the present invention. The power supply 60 powers a load 20, and is capable of stabilizing the voltage of a remote output power V_{O-R}.

The power supply 60 comprises a power controller 62, a buck converter 12, a transmission line 18 and a feedback circuit 70.

For example, the power controller 62 may be an integrated circuit, and includes (but not limited to) pins of a feedback node FB, a high side node HS and a low side node LS. The buck converter 12 converts an input voltage power V_{IN} in a relatively high voltage to a near output power V_{O-N} in a relatively low voltage. The transmission line 18 is connected between a near output node O_{N} and a remote output node O_{R}, and is a low-pass transmission line as parasitic inductance and resistance in the transmission line 18 form a low-pass circuit. An output capacitor C_{O} is connected between the near output node O_{N} and a ground node GND. A decoupling capacitor C_{DECAP} is connected between the remote output node O_{R} and the ground node GND.

A feedback circuit 70 includes a feedback capacitor C_{FB}, a resistor R₁ and a resistor R₂. The feedback capacitor C_{FB} is connected between the near output node O_{N} and the feedback node FB. The resistors R₁ and R₂, regarding the feedback node FB as a contact, are connected in series between the remote output node O_{R} and the ground node GND. Through simple circuit deduction, it is obtained that, the relationship of the feedback signal V_{FB}, the remote output power V_{O-R} and the near output power V_{O-N} may be represented as equation (1) below:

$$VFB = VON * \frac{( i * 2 π f * CFB ) * R 1 // R 2}{1 + ( i * 2 π f * CFB ) * R 1 // R 2} + VOR * \frac{R 1 / ( R 1 + R 2 )}{i * 2 π f * CFB * ( R 1 // R 2 ) + 1} \qquad ( 1 )$$

In equation (1), VFB, VON and VOR are the voltages of the feedback signal V_{FB}, the near output power V_{O-N} and the remote output power V_{O-R}, respectively, CFB is the capacitance value of the feedback capacitor C_{FB}, i is an imaginary number, f is the signal frequency, R1 and R2 are the resistance values of the resistors R₁ and R₂, respectively, and R1//R2 represents an equivalent resistance value of the resistors R₁ and R₂ connected in parallel.

The feedback circuit 70 provides low-pass filter to the remote output power V_{O-R} on the remote output node O_{R}, and is capable of generating a low-pass signal (i.e., the last half of equation (1)) of the remote output power V_{O-R} on the feedback node FB. The feedback circuit 70 also provides high-pass filter to the near output power V_{O-N} on the near output node O_{N}, and is capable of generating a high-pass signal (i.e., the first half of equation (1)) of the near output power V_{O-N} on the feedback node FB. Thus, in FIG. 3, the feedback signal V_{FB} on the feedback node FB is approximately the combination of a voltage level of the remote output power V_{O-R} (i.e., the low-pass signal in this embodiment), and a voltage level of the near output power V_{O-N} (i.e., the high-pass signal in this embodiment). In other embodiments, the feedback circuit 70 may be formed by other circuit structures, and the same effect can be achieved, given that the voltage level of the remote output power V_{O-R} and the voltage level of the near output power V_{O-N} can be provided at the feedback node FB.

The power controller 62 is operable in a ripple mode. The so-called “ripple mode” refers to an operating mode triggered by the voltage of the output power. The power controller 62 performs electric power conversion by a power converter in the ripple mode. For example, the power controller 62 includes a comparator 64 and a pulse generator 68. The comparator 64 compares the feedback signal V_{FB} with a reference signal V_{REF}, which may be a fixed 2.5V voltage. According to the difference between the feedback signal V_{FB} and the reference signal V_{REF}, the comparator 64 outputs a digital comparison result S_{OUT}. When the digital comparison result S_{OUT} changes from logic “0” to logic “1” (the feedback signal V_{FB} is lower than the reference signal V_{REF}), the pulse generator 68 is triggered to provide a pulse on the high side node HS. When the comparison result S_{OUT} maintains at logic “0” (the feedback signal V_{FB} is higher than the reference signal V_{REF}), the pulse is not provided. Compared to a common power controller adopting an operational amplifier, the power controller 62 operating in the ripple mode has a faster response time, and causes the remote output power V_{O-R} to have a smaller output ripple.

The buck converter 12 includes a high side power switch SW_{HS}, a low side power switch SW_{LH}, and an inductor L. The pulse width of a pulse on the high side node HS substantially determines the on-time T_{ON} of the high side power switch SW_{HS}. For example, when the feedback signal V_{FB} is lower than the reference signal V_{REF}, the comparator 64 outputs the digital comparison result S_{OUT} in logic “1”, and the pulse generator 68 accordingly provides a pulse at the high side node HS to turn on the high side power switch SW_{HS}.

FIG. 4 depicts the signal S_{HS} on the high side note HS, the signal S_{LS} on the low side node LS, the feedback signal V_{FB} on the feedback node FB, and the digital comparison result S_{OUT}. The signal S_{HS} includes a plurality of digital pulses. The pulse width of each pulse is referred to as an on-time T_{ON}. A period between two consecutive pulses is referred to as a off-time T_{OFF}. The sum of one on-time T_{ON} and one off-time T_{OFF} is referred to as a conversion cycle T_{CYC}. At a time t₀, the feedback signal V_{FB} is lower than the reference signal V_{REF}, a pulse appears in the signal S_{HS}, the high side power switch SW_{HS} is turned on, and the on-time T_{ON} begins. When the on-time T_{ON} ends, another pulse appears in the signal S_{LS} to turn on the low side power switch SW_{LS}. The low side power switch SW_{LS} provides a function of synchronous filter (SR).

The power controller 62 is operable in a minimum off-time mode. That is, the off-time T_{OFF} after one on-time T_{ON} is not shorter than one minimum off-time T_{OFF-MIN}. In other words, after having been turned off at a time point t₁, the high side power switch SW_{HS} is again turned on only after at least the minimum off-time T_{OFF-MIN} to enter the next on-time T_{ON}. For example, in FIG. 3, when the feedback signal V_{FB} is lower than the reference signal V_{REF} and the off-time T_{OFF} exceeds the minimum off-time T_{OFF-MIN}, the pulse generator 68 provides another pulse on the high side node HS at a time point t₂ to start a next on-time T_{ON}.

The power controller 62 is operable in a constant on-time mode. That is to say, the on-time T_{ON} is persistently a constant value. In another embodiment, although the on-time T_{ON} in multiple adjacent conversion cycles is substantially the same, the on-time T_{ON} may still be gradually adjusted according to the detection result in the long term.

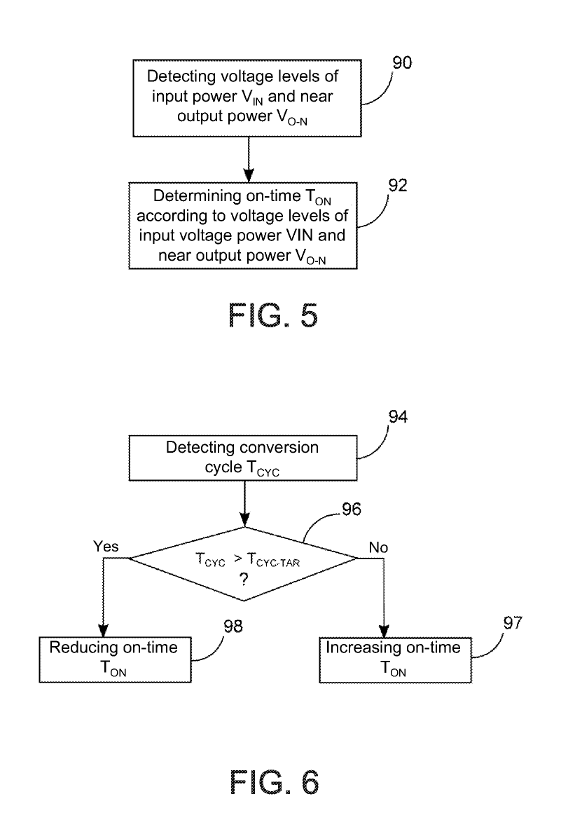

FIG. 5 shows a control method for the on-time T_{ON}. The control method may be applied to the power controller 62. In step 90, the pulse generator 68 detects the voltages of the input voltage power V_{IN} and the near output power V_{O-N}. In step 92, the on-time T_{ON} is determined according to the detection result. For example, T_{ON}=K*VON/VIN (equation (1)), where K is a constant value, V_{ON} is the voltage of the near output power V_{O-N}, and V_{IN} is the voltage of the input voltage power V_{IN}. When the on-time T_{ON} is controlled according to equation (1) and the buck converter 12 operates is a continuous conduction mode (CCM), the conversion cycle T_{CYC} is substantially maintained at a constant value. The so-called CCM is that, the energy stored in an inductor component is not yet completely released when one conversion cycle ends and the next conversion cycle already begins. In contrast, a discontinuous conduction mode (DCM) is that, the energy stored in an inductor component is completely released when one conversion cycle ends and a next conversion cycle then only begins.

FIG. 6 shows a control method of the on-time T_{ON}. The method is also applicable to the power controller 62. In step 94, the conversion cycle T_{CYC} is detected. For example, the time length between two successive rising edges or falling edges in the signal S_{HS} is detected. In step 96, the conversion cycle T_{CYC} is compared with a target conversion cycle T_{CYC-TAR}. When the conversion cycle T_{CYC} is longer than the target conversion cycle T_{CYC-TAR}, the on-time T_{ON} is reduced in step 98. As the on-time T_{ON} is shorter due to less electric energy is stored in the inductor L, the near output power V_{O-N} and the remote output power V_{O-R} drop earlier, and the subsequent conversion cycle T_{CYC} may be shortened. Conversely, when the conversion cycle T_{CYC} shorter than the target conversion cycle T_{CYC-TAR}, the on-time T_{ON} is increased in step 97. The control method in FIG. 6 is capable of causing the conversion cycle T_{CYC} to be close to the target conversion cycle T_{CYC-TAR}.

By using a remote output value of the remote output power V_{O-R} and a near output value of the near output power V_{O-N} as feedback, the power supply 60 in FIG. 3 is capable of providing a sufficiently fast response speed to stabilize the voltage of the remote output power V_{O-R}.

It should be noted that, the synchronous rectification buck converter operating in a ripple mode in FIG. 3 is taken as an example, and is not to be construed as a limitation to the present invention. For example, the present invention is also applicable to an asynchronous power converter as well as a boost converter.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power supply, powering a load, comprising:
a power converter, converting an input power to a near output power, comprising:
a power input node, receiving the input power; and
a near output node, outputting the near output power;
a remote output node, providing a remote output power to the load;
a transmission line, connected between the near output node and the remote output node;
a feedback circuit, generating a feedback signal according to a voltage level of the remote output power and a voltage level of the near output power; and
a power controller, outputting control signal to the power converter according to the feedback signal and a reference signal, the power converter converting the input power to the near output power according to the control signal.

2. The power supply according to claim 1, wherein the feedback circuit comprises:
a voltage dividing circuit, comprising two resistors, connected in series between the remote output node and a ground node via a feedback node; and
a feedback capacitor, connected between the feedback node and the near output node.

3. The power supply according to claim 1, wherein the power converter is a buck converter and comprises a power switch controlled by the control signal, the control signal comprises a pulse, and a pulse width of the pulse is associated with an on-time of the power switch.

4. The power supply according to claim 3, wherein the power controller detects the input power to control the pulse width.

5. The power supply according to claim 3, wherein the power controller detects the near output power to control the pulse width.

6. The power supply according to claim 3, wherein the power controller detects a conversion cycle of the power converter to control the pulse width.

7. The power supply according to claim 1, wherein the control signal comprises a pulse, the power converter comprises:
a comparator, comparing the feedback signal with a reference signal to generate a digital comparison result; and
a pulse generator, connected to the comparator, outputting the pulse when the digital comparison result changes state.

8. The power supply according to claim 1, wherein the remote output power is a low-pass signal, and the near output power is a high-pass signal.

9. A control method, controlling a power supply to power a load, the power supply comprising a power input node receiving an input power, a near output node outputting a near output power converted from the input power, and a remote output node providing a remote output power to the load, the near output node and the remote output node connected via a transmission line, the control method comprising:
receiving the remote output power;
receiving the near output power;
generating a feedback signal according to a level of the remote output power and a level of the near output power;
generating a control signal according to the feedback signal and a reference signal; and
converting the input power to the near output power according to the control signal.

10. The control method according to claim 9, wherein the power converter further comprises a power switch, the control method further comprising:
turning on the power switch to adjust a voltage of the near output power;
wherein, the control signal comprises a pulse, and a pulse width of the pulse is associated with an on-time of the power switch.

11. The control method according to claim 10, further comprising:
detecting the input power to control the pulse width.

12. The control method according to claim 10, further comprising:
detecting the near output power to control the pulse width.

13. The control method according to claim 10, wherein the step of converting the input power to the near output power comprises a conversion cycle, the control method further comprising:
detecting the conversion cycle to control the pulse width.

14. The control method according to claim 9, wherein the step of generating the control signal according to the feedback signal and the reference signal comprises:
comparing the feedback signal with the reference signal to generate a digital comparison result; and
outputting the control signal when the digital comparison result changes state.

15. The control method according to claim 9, wherein the remote output power is a low-pass signal, and the near output power is a high-pass signal.
